(19) United States
(12) Patent Application Publication
(10) Pub. No.: US 2013/0110983 A1
(43) Pub. Date: May 2, 2013

(54) METHOD AND SYSTEM FOR REMOTELY MANAGING DIGITAL CONTENTS

(71) Applicants: Byung-youn Song, Suwon-si (KR); Nag-eui Choi, Suwon-si (KR); Seung-ki Kim, Suwon-si (KR); Ho-jin Kang, Incheon (KR)

(72) Inventors: Byung-youn Song, Suwon-si (KR); Nag-eui Choi, Suwon-si (KR); Seung-ki Kim, Suwon-si (KR); Ho-jin Kang, Incheon (KR)

(21) Appl. No.: 13/613,745

(22) Filed: Sep. 13, 2012

(30) Foreign Application Priority Data
Oct. 27, 2011 (KR) 10-2011-0110696

(51) Int. Cl. G06F 15/16

(52) U.S. Cl. 709/219

(57) ABSTRACT

Provided is method and system for remotely managing digital contents. A digital content folder is generated and has a size corresponding to a capacity of an optical disc. Digital contents may be uploaded to the digital content folder. The digital contents uploaded to the digital content folder may be copied to an optical disc that has a size corresponding to the size of the digital content folder.

### CROSS-REFERENCE TO RELATED APPLICATION(S)

This application claims the benefit under 35 USC §119(a) of Korean Patent Application No. 10-2011-0110696, filed on Oct. 27, 2011, in the Korean Intellectual Property Office, the entire disclosure of which is incorporated herein by reference for all purposes.

### BACKGROUND 1. Field

The following description relates to a method for remotely managing digital contents, and a system adopting the method.

2. Description of Related Art

There are various types of systems which are capable of storing digital contents and managing them, for example, a server system that exists in the Internet. The server system may receive a request to copy digital contents stored in the server system via a predetermined order interface. When an order is received, copy-target digital contents are selected from a digital content group stored in the server system, and the system copies the selected copy-target digital contents on a physical medium such as a disc, to then deliver it to the requester.

However, in management of the digital contents that are uploaded to the server system, a user has to select each target digital contents and in a particular order, which may cause inconvenience to the user. Therefore, there is a demand for a solution with respect to this problem.

### SUMMARY

In an aspect, there is provided a method of remotely managing digital contents, the method including generating a digital content folder in a user storage area of a server system, the digital content folder comprising a size corresponding to a capacity of an optical disc, and uploading digital contents to the digital content folder.

The digital content folder may comprise a size in correspondence to the capacity of an optical disc selected from among a plurality of different types of optical discs.

The method may further comprise copying the digital contents uploaded to the digital content folder to an optical disc.

The copying of the digital content may comprise selecting an optical disc that comprises a size corresponding to the size of the digital content folder.

The method may further comprise delivering the optical disc including the digital contents to a user.

The copying of the digital content may be automatically performed at predetermined intervals.

The capacity of the optical disc may comprise a capacity of at least one of a compact disc (CD), a digital versatile disc (DVD), and a Blu-ray (BD).

In an aspect, there is provided a system for remotely managing digital contents, the system including a digital content storage server system configured to generate and provide a digital content folder in a user storage area, the digital content folder comprising a size corresponding to a capacity of an optical disc, a client system configured to upload digital contents to the digital content folder of the digital content storage server system, and a network interface system configured to provide a digital content transmission path between the digital content storage server system and the client system.

The digital content folder may comprise a size in correspondence to the capacity of an optical disc selected from among a plurality of different types of optical discs.

The system may further comprise an optical disc copier configured to copy the digital contents stored in the digital content folder to an optical disc.

The copying of the digital content may comprise selecting an optical disc that comprises a size corresponding to the size of the digital content folder.

The system may further comprise a mailing system for delivering the optical disc.

The optical disc copier may copy digital contents to the optical disc at predetermined intervals.

The capacity of the optical disc may comprise a capacity of at least one of a compact disc (CD), a digital versatile disc (DVD), and a Blu-ray (BD).

Other features and aspects may be apparent from the following detailed description, the drawings, and the claims.

### BRIEF DESCRIPTION OF THE DRAWINGS

FIG. 1 is a diagram illustrating an example of a digital content remote management system.

FIG. 2 is a diagram illustrating examples of graphic user interface screens for initial generation of a unit folder to store digital contents.

FIG. 3 is a diagram illustrating an example of a folder selection window for an upload of digital contents to a digital content folder in a remote server system.

FIG. 4 is a diagram illustrating an example of a user interface screen showing a list of digital contents uploaded to a digital content folder in a remote server system.

FIG. 5 is a diagram illustrating an example of a guide screen that is displayed in excess of a capacity when digital contents are uploaded to a digital content folder.

FIG. 6 is a diagram illustrating an example of a guide screen for selection of a digital content folder which is requested for an optical disc copying operation.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

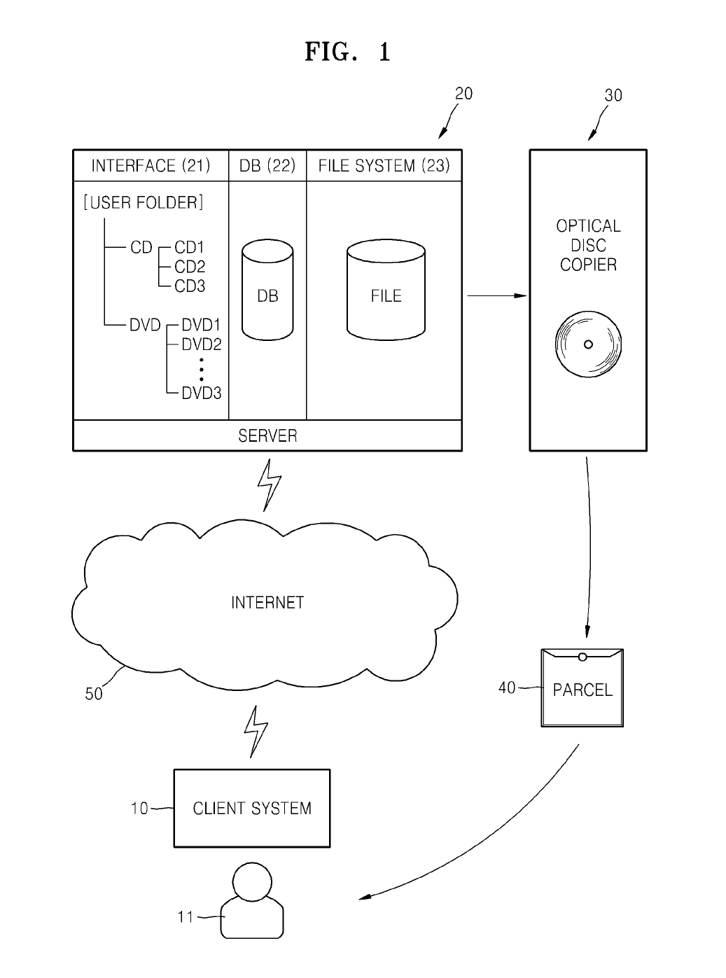

FIG. 1 illustrates an example of a digital content remote management system.

Referring to FIG. 1, a client system 10 and a digital content server system 20 are connected through a network interface system 50, for example, via the Internet. The client system 10 may include a terminal, for example, a personal computer, a mobile phone, a tablet, an appliance, a television, and the like.

The digital content server system 20 includes a file system 23 that provides storage space for storing digital contents that may be uploaded and managed by a user 11. The digital content server system 20 includes an interface 21 that is a virtual file system for displaying the digital contents stored in the file system 23. The interface 21 may be a user interface (UI) such as a graphical user interface (GUI). The digital content server system 20 includes a database (DB) 22 that stores and manages user information and information about user-registered digital contents.

The interface 21 provides a visual display screen that may be accessed by the client system 10, and displays the digital contents which are uploaded and managed by the user 11. For example, the interface 21 may display the contents in a list of unit folders. According to various aspects, the unit folders may have a size corresponding to a capacity or a size of an optical disc, for example, a compact disc (CD), a digital versatile disc (DVD), a Blu-ray (BD), and the like. The list may be displayed in the form (an array) of a list view, a tree-view, an icon browse, and the like.

The client device 10 includes features which enable a user to manipulate the display of digital contents by the digital content server system 20. For example, the client device 10 may include a mouse, keyboard, touch pad, touch screen, and the like, to receive user input.

An optical disc copier 30 is connected to the digital content server system 20. The optical disc copier 30 copies the unit folder to the optical disc. For example, digital contents in a unit folder may be copied to a corresponding optical disc. For example, the optical disc may be selected based on a size of the unit folder, and information about the unit folder may be stored in the DB 22.

The optical disc is a physical medium that may be generated by the optical disc copier 30. The optical disc may be delivered to the user 11, for example, via a mailing system 40 such as a general parcel. As another example, the optical disc may be directly received by a user in-person.

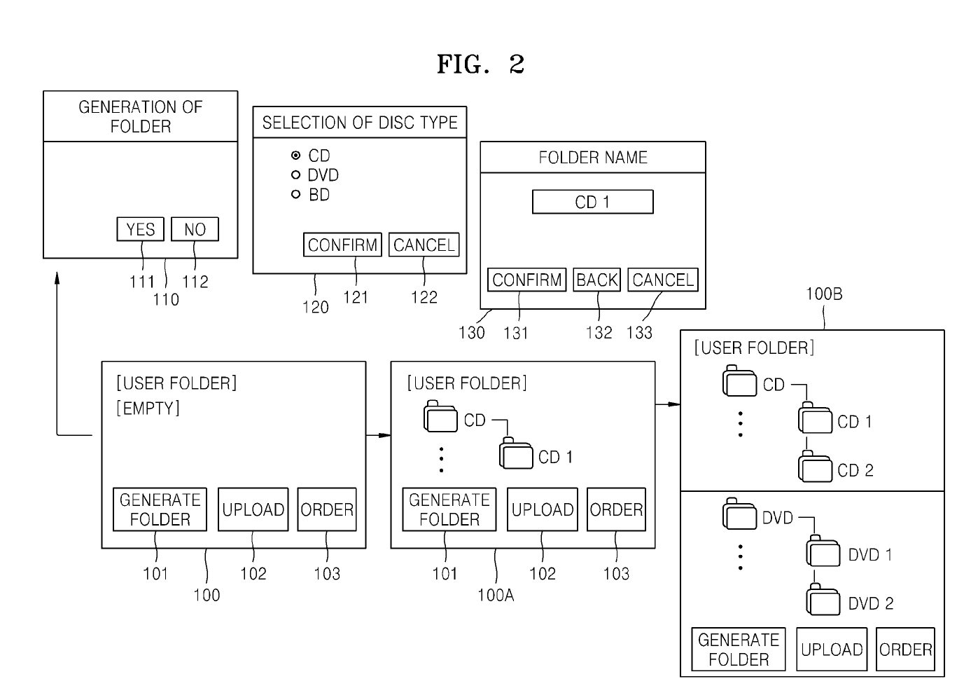

FIG. 2 illustrates examples of interface screens including an interface window 100 for initial generation of a unit folder to store digital contents.

Referring to FIG. 2, a user folder is a user storage area. In the initial interface window 100 the user folder may be empty. For example, the interface window 100 may include a folder generation button 101, an upload button 102, a copy order button 103, and the like. It should be appreciated that the buttons may be provided in a different menu type format.

In the initial state, when a user presses the folder generation button 101 to generate a unit folder, a pop-up window 110 may be displayed. In response, the user is prompted with whether or not to continue to generate the folder. Here, if the user presses a ‘YES’ button 111, a pop-up window 120 that requests for optical disc selection may be displayed. In this regard, if the user selects a CD item and presses a ‘CONFIRM’ button 121, a folder name input window 130 may be sequentially displayed. As another example, if the user presses a ‘CANCEL’ button 122, the interface window 100 in the initial state may be displayed. After selecting the CD item, the user inputs ‘CD1’ in the folder name input window 130 and then presses a ‘CONFIRM’ button 131. In response, an interface window 100A in which a CD1 folder is newly generated may be displayed.

Afterward, if the user presses a ‘BACK’ button 132, the pop-up window 120 may be displayed, or if the user presses a ‘CANCEL’ button 133, the interface window 100 in the initial state may be displayed. If the user again presses the folder generation button 101 in the interface window 100A in which the CD1 folder is newly displayed, another folder may be generated in the aforementioned manner, and an updated interface window 100B including the newly generated folder may be displayed.

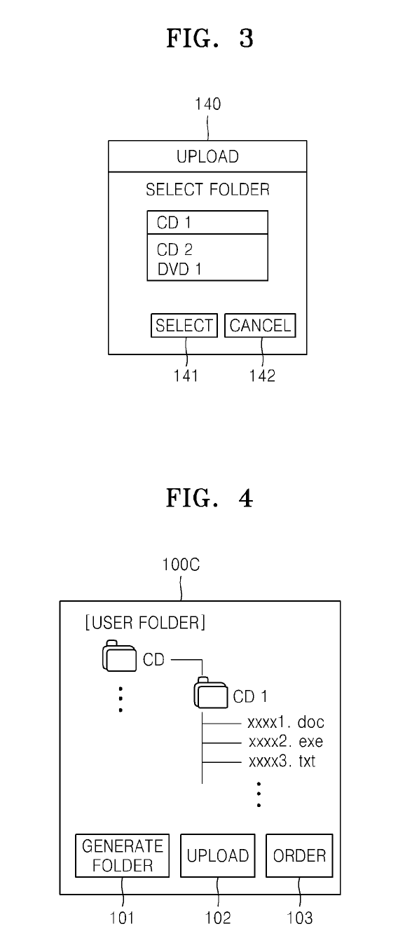

When the user presses the upload button 102 in the interface windows 100, 100A, and 100B, a medium selection menu window 140 shown in FIG. 3 may be displayed. For example, a selectable folder list may include folders that are displayed on the interface windows 100, 100A, and 100B. The folders may be obtained from the DB 22 of the digital content server system 20 that has information about the folders. If the user selects the CD1 folder from among the folders displayed in a list, and then presses a ‘CONFIRM’ button 141, a window (not shown) such as a general upload window may be displayed to allow the user to select a file of a storage medium of a local computer. In this example, a file may be selected by the user via the window, and digital contents of the client system 10 may be uploaded and stored in the file system 23 of the digital content server system 20 via the network interface system 50. The uploaded information may be stored in the DB 22. In response, as illustrated in the example of FIG. 4, a list of the digital contents (xxxx1.doc, xxxx2.exe, xxxx3.txt, and the like) may be displayed on an interface window 100C.

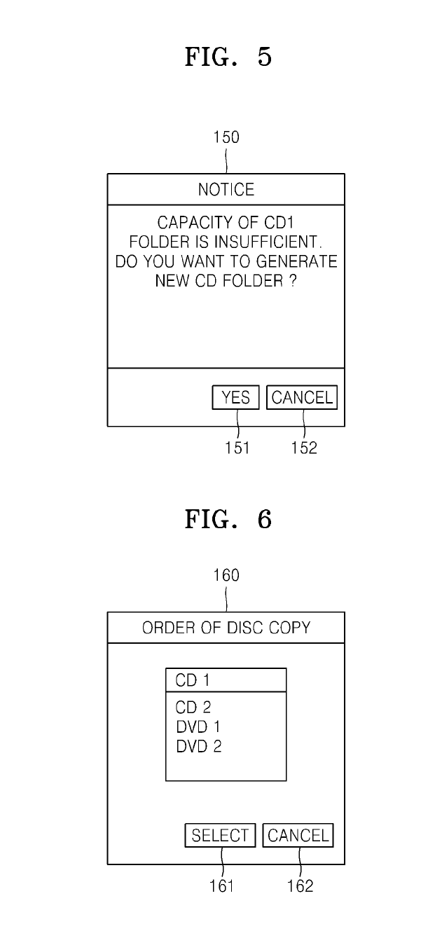

As illustrated in FIG. 3, if the user selects the CD1 folder from among the folders shown in the list, presses the ‘CONFIRM’ button 141, and selects an upload target file via a window for selection of a file in a storage medium of a local computer, the selected upload target file may not be accepted due to an insufficient remaining capacity of the CD1 folder. In this example, a guide window 150 may be displayed as illustrated in FIG. 5. Accordingly, when the user presses a new CD folder generation button 151, a new folder may be formed via the process described above with reference to FIG. 2, and the user may upload target digital contents. By using the aforementioned process, it is possible to manage the unit folders while matching the unit folders with a capacity of a particular physical medium such as a CD, a DVD, and a BD. Accordingly, it is possible to manage folders as if folders in the digital content server system 20 were actual optical discs.

If the user presses the copy order button 103 in the interface windows 100, 100A, and 100B, a unit folder list in units of a size of an optical disc may be displayed as illustrated in FIG. 6. Here, if the user selects a CD1 and presses a ‘SELECTION’ button 161, the digital content server system 20 recognizes copying of digital contents in the CD1 folder to a CD, copies the digital contents in the CD1 folder to the CD, and delivers the CD to the user 11, for example, in person or via the mailing system 40.

As a result, the user 11 may have an optical disc containing the same contents as those of the folders in the digital content server system 20 which are managed in units of optical discs. In this example, if the user deletes some of the digital contents in a unit folder and uploads new digital contents, the digital content server system 20 will have the unit folder containing the new digital contents. In this regard, upon user's request, the user may have a new optical disc delivered containing the uploaded new digital contents.

In some examples, the aforementioned disc copying operation may not be performed according to user selection but may be automatically performed at a predetermined period, for example, once a month. As described herein, a digital content folder that is updated or changed by the user may be periodically copied and delivered to the user, so that digital contents that are important to the user may be stably maintained. In addition, the user may have a disc that is periodically updated, so that the user may deal with a situation in which an error or an access denial occurs with respect to the digital content server system 20.

Although not illustrated in the aforementioned examples, a specific folder that has already been generated may be deleted or renamed, and it is also possible that digital contents in a specific folder may be moved to another specific folder within an allowable capacity of the other specific folder that is a target folder.

A user storage area of the digital content server system 20 which is accessible to the user has unit folders. The unit folders may be managed in a size corresponding to a capacity of an optical disc. Generation of the unit folder in the user storage area may be selected by the user or the digital content server system 20, and a size of the unit folder may correspond to a capacity of an optical disc to which digital contents are to be copied. The user may upload, download, and selectively delete digital contents with respect to the unit folders. When the user orders a copy of the digital contents, the user may manage digital contents to be contained in each optical disc, according to a unit folder that is managed in a capacity of an optical disc.

According to various aspects, a folder in the digital content server system is managed in the form of a folder corresponding to a type of optical disc, such that a complicated procedure for copying digital contents to a disc is not required. As a result, the user may permanently and stably maintain and manage digital contents that are uploaded to the digital content server system by the user, and may have important digital contents not only in a remote server system but also in user's hand, so that the user experience may be improved.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of remotely managing digital contents, the method comprising:
generating a digital content folder in a user storage area of a server system, the digital content folder comprising a size corresponding to a capacity of an optical disc; and
uploading digital contents to the digital content folder.

2. The method of claim 1, wherein the digital content folder comprises a size in correspondence to the capacity of an optical disc selected from among a plurality of different types of optical discs.

3. The method of claim 1, further comprising copying the digital contents uploaded to the digital content folder to an optical disc.

4. The method of claim 3, wherein the copying of the digital content comprises selecting an optical disc that comprises a size corresponding to the size of the digital content folder.

5. The method of claim 3, further comprising delivering the optical disc including the digital contents to a user.

6. The method of claim 4, wherein the copying of the digital content is automatically performed at predetermined intervals.

7. The method of claim 1, wherein the capacity of the optical disc comprises a capacity of at least one of a compact disc (CD), a digital versatile disc (DVD), and a Blu-ray (BD).

8. A system for remotely managing digital contents, the system comprising:
a digital content storage server system configured to generate and provide a digital content folder in a user storage area, the digital content folder comprising a size corresponding to a capacity of an optical disc;
a client system configured to upload digital contents to the digital content folder of the digital content storage server system; and
a network interface system configured to provide a digital content transmission path between the digital content storage server system and the client system.

9. The system of claim 8, wherein the digital content folder comprises a size in correspondence to the capacity of an optical disc selected from among a plurality of different types of optical discs.

10. The system of claim 8, further comprising an optical disc copier configured to copy the digital contents stored in the digital content folder to an optical disc.

11. The system of claim 10, wherein the copying of the digital content comprises selecting an optical disc that comprises a size corresponding to the size of the digital content folder.

12. The system of claim 10, further comprising a mailing system for delivering the optical disc.

13. The system of claim 10, wherein the optical disc copier copies digital contents to the optical disc at predetermined intervals.

14. The system of claim 12, wherein the capacity of the optical disc comprises a capacity of at least one of a compact disc (CD), a digital versatile disc (DVD), and a Blu-ray (BD).
